(19) United States
(12) Patent Application Publication
(10) Pub. No.: US 2023/0412503 A1
(43) Pub. Date: Dec. 21, 2023

(54) DETERMINING UNICAST ADDRESSES OF GATEWAY NETWORK DEVICES ASSOCIATED WITH AN ANYCAST ADDRESS IN VXLAN-EVPN DCI ENVIRONMENTS

(71) Applicant: Juniper Networks, Inc., Sunnyvale, CA (US)

(72) Inventors: Zhaohui ZHANG, Westford, MA (US); Jagadish N. GRANDHI, Hyderabad (IN); Vinod Kumar GORNAL M., Bangalore (IN); Pratibha GOEL, Bangalore (IN)

(21) Appl. No.: 17/957,773

(22) Filed: Sep. 30, 2022

(30) Foreign Application Priority Data
Mar. 7, 2022 (IN) 202241012138

(51) Int. Cl. H04L 45/74; H04L 45/42; H04L 12/46

(52) U.S. Cl. CPC H04L 45/74; H04L 12/4641; H04L 45/42

(57) ABSTRACT

A network device may receive, from an origination device associated with a first VxLAN, traffic destined for a destination device associated with a second VxLAN, wherein the network device is a VTEP of the first VxLAN. The network device may identify an address of the destination device included in the traffic and may thereby determine an anycast address associated with an EVPN DCI that is associated with the first VxLAN and the second VxLAN. The network device may determine, based on the anycast address, respective unicast addresses of a plurality of gateway network devices associated with the EVPN DCI, and may thereby identify a particular gateway network device, of the plurality of gateway network devices, to which the traffic is to be forwarded. The network device may forward the traffic to a unicast address of the particular gateway network device.

### CROSS-REFERENCE TO RELATED APPLICATION

This application claims priority to India Patent Application No. 202241012138, entitled “ANYCAST AFFINIATION ADVERTISEMENT,” and filed on Mar. 7, 2022. The entire content of the above-referenced application is expressly incorporated herein by reference.

### BACKGROUND

An Ethernet virtual private network (EVPN) enables connectivity using a Layer 2 virtual bridge. An EVPN provides virtual multipoint bridged connectivity between domains over an Internet protocol (IP) or an IP/multiprotocol label switching (MPLS) core network. In some cases, an EVPN enables multipoint Layer 2 virtual private network (VPN services), such as multi-homing capabilities, and uses a border gateway protocol (BGP) control plane over the core IP/MPLS network. Virtual extensible local area network (VxLAN) is an encapsulation protocol that provides data center connectivity using tunneling to stretch Layer 2 connections over an underlying Layer 3 network. VxLAN enables optimal forwarding of Ethernet frames with support for multipathing of unicast and multicast traffic. VxLAN uses user datagram protocol (UDP)/IP encapsulation for tunneling. VxLAN and EVPN instances are configured on provider edge (PE) devices to maintain logical service separation between customer end point devices. The PE devices connect to customer edge (CE) devices.

### SUMMARY

Some implementations described herein relate to a method. The method may include receiving, by a first network device, traffic that is to be forwarded to an anycast address associated with a second network device and a third network device. The method may include sending, by the first network device, the traffic to a unicast address of one or more unicast addresses associated with the anycast address.

Some implementations described herein relate to a non-transitory computer-readable medium that stores a set of instructions for a first network device. The set of instructions, when executed by one or more processors of the first network device, may cause the first network device to receive traffic that is to be forwarded to an anycast address associated with a second network device and a third network device. The set of instructions, when executed by one or more processors of the first network device, may cause the first network device to send the traffic to a unicast address of one or more unicast addresses associated with the anycast address.

Some implementations described herein relate to a network device. The network device may include one or more memories and one or more processors. The network device may be configured to identify an anycast address that is associated with the network device. The network device may be configured to identify a unicast address of the network device. The network device may be configured to advertise the anycast address and the unicast address to one or more other network devices.

In some implementations, a method includes receiving, by a network device and from an origination device associated with a first VxLAN, traffic destined for a destination device associated with a second VxLAN, wherein the network device is a VxLAN tunnel end point (VTEP) of the first VxLAN; identifying, by the network device, an address of the destination device included in the traffic; determining, by the network device and based on the address of the destination device, an anycast address associated with an Ethernet virtual private network data center interconnect (EVPN DCI) that is associated with the first VxLAN and the second VxLAN; determining, by the network device and based on the anycast address, respective unicast addresses of a plurality of gateway network devices associated with the EVPN DCI; identifying, by the network device and based on the respective unicast addresses of the plurality of gateway network devices, a particular gateway network device, of the plurality of gateway network devices, to which the traffic is to be forwarded; and forwarding, by the network device, the traffic to a unicast address of the particular gateway network device.

In some implementations, a non-transitory computer-readable medium storing a set of instructions includes one or more instructions that, when executed by one or more processors of a network device, cause the network device to: receive, from an origination device associated with a first VxLAN, traffic destined for a destination device associated with a second VxLAN, wherein the network device is a VTEP of the first VxLAN; determine, based on the traffic, an anycast address associated with an EVPN DCI that is associated with the first VxLAN and the second VxLAN; determine, based on the anycast address, respective unicast addresses of a plurality of gateway network devices associated with the EVPN DCI; and forward, based on the respective unicast addresses of the plurality of gateway network devices, the traffic to a unicast address of a particular gateway network device of the plurality of gateway network devices.

In some implementations, a network device includes one or more memories, and one or more processors to: identify an anycast address that is associated with an EVPN DCI that is associated with a first VxLAN and a second VxLAN, wherein the network device is a gateway network device of the EVPN DCI for the first VxLAN; identify a unicast address of the network device; generate an advertisement message that indicates the anycast address and the unicast address; and advertise the advertisement message to one or more other network devices associated with the first VxLAN.

### BRIEF DESCRIPTION OF THE DRAWINGS

FIGS. 1A-1E are diagrams of one or more example implementations described herein.

FIG. 2 is a diagram of an example environment in which systems and/or methods described herein may be implemented.

FIG. 3 is a diagram of example components of a device, which may correspond to a CE network device, a PE network device, and/or a provider (P) network device.

FIG. 4 is a diagram of example components of a device, which may correspond to a CE network device, a PE network device, and/or a P network device.

FIG. 5 is a flowchart of an example process associated with determining unicast addresses of gateway network devices associated with an anycast address in VxLAN-EVPN DCI environments.

FIG. 6 is a flowchart of an example process associated with determining unicast addresses of gateway network devices associated with an anycast address in VxLAN-EVPN DCI environments.

### DETAILED DESCRIPTION

The following detailed description of example implementations refers to the accompanying drawings. The same reference numbers in different drawings may identify the same or similar elements.

In some cases, two different VxLANs can be connected via an EVPN. For example, first protocol independent multicast (PIM)-based dynamic VxLAN can include a CE device A (“CE-A”), a PE device that is configured as a VxLAN tunnel endpoint (VTEP) (“VTEP-A”) connected to CE-A, a P device configured as a provider router (“P-A”) connected to VTEP-A, and two PE devices (gateways “GW1-A” and “GW2-A”) connected to P-A. GW1-A and GW2-A can provide multihoming for site A (e.g., in all-active redundancy mode) via respective VxLAN tunnels. GW1-A and GW2-A can be at the edge of an EVPN DCI (e.g., act as gateways between site A and the EVPN DCI). Moreover, a second PIM-based dynamic can include a CE device B (“CE-B”), a PE device that is configured as a VTEP (“VTEP-B”) connected to CE-B, a PE device configured as a provider router (“P-B”) connected to VTEP-B, and two PE devices (gateways “GW1-B” and “GW2-B”) connected to P-B. GW1-B and GW2-B can provide multihoming for site B (e.g., in all-active redundancy mode) via respective VxLAN tunnels. GW1-B and GW2-B can be at the edge of the EVPN DCI (e.g., act as gateways between site B and the EVPN DCI).

Typically, gateways share a common anycast address for routing traffic that originates from a VxLAN associated with the gateways. For example, GW1-A and GW2-A share an anycast address associated with site A, and GW1-B and GW2-B share an anycast address associated with site B. In this way, when equal-cost multi-path (ECMP) links to GW1-A and GW2-A (e.g., from VTEP-A and/or P-A) are employed, traffic that originates from CE-A and that is destined for CE-B can be load-balanced across GW1-A and GW2-A (e.g., because VTEP-A and/or P-A can distinguish between GW1-A and GW2-A). However, in many cases, ECMP links are not employed, and therefore load-balancing is not available. This can impact transmission (e.g., by introducing latency, delay, or packet loss, among other examples) of packets from site A to site B, which impacts an overall performance of site A, the EVPN DCI, and site B.

In some implementations, gateway network devices (e.g., a GW1 and GW2) of a VxLAN may have respective unicast addresses (e.g., that are each associated, also termed “affiniated,” with an anycast address of the gateway network devices). A VTEP of the VxLAN may determine and use the respective unicast addresses of the gateway network devices to balance communication of traffic, from the VxLAN to another VxLAN via an EVPN DCI, across the gateway network devices.

In some implementations, the respective unicast addresses of the gateway network devices may be static, and the VTEP may process configuration information (e.g., that is included in the VTEP) to identify the respective unicast addresses of the gateway network devices. Additionally, or alternatively, each of the gateway network devices may send, to the VTEP, an advertisement message (e.g., as part of an advertisement process). The advertisement message may include information identifying a unicast address and an anycast address (e.g., of the gateway network device sending the advertisement message).

In this way, some implementations described herein enable load-balancing across the gateway network devices of a VxLAN, even when no ECMP links are employed. This reduces a likelihood that latency, delay, or packet loss, among other examples, is introduced to transmission of packets from a first VxLAN to a second VxLAN via an EVPN DCI when no ECMP links are employed. This therefore improves a performance of the first VxLAN, the second VxLAN, and the EVPN DCI.

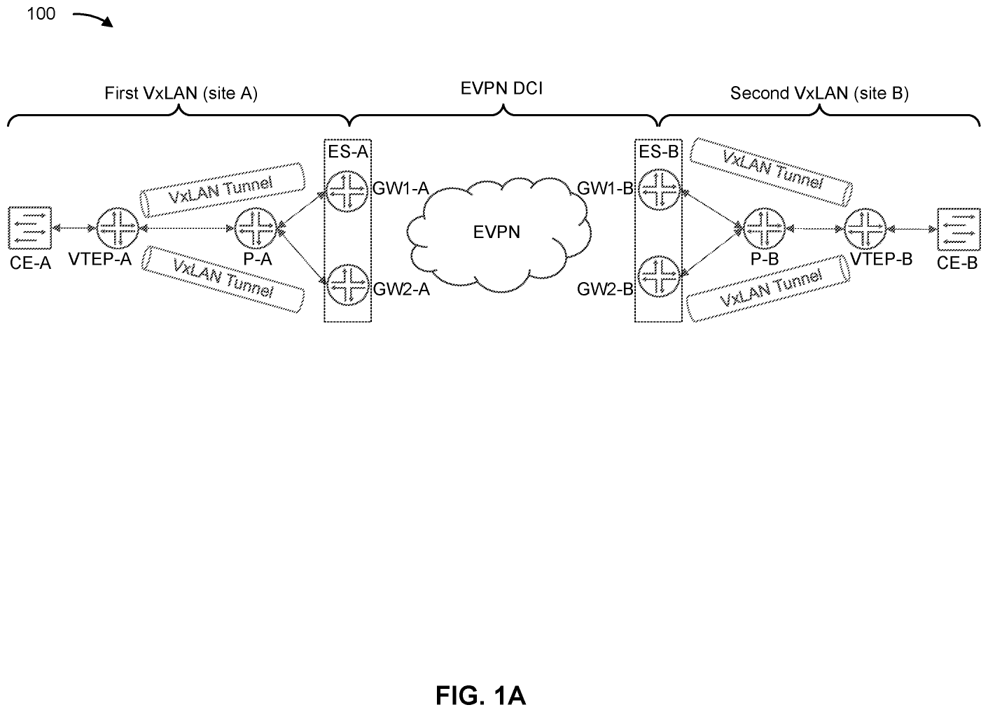

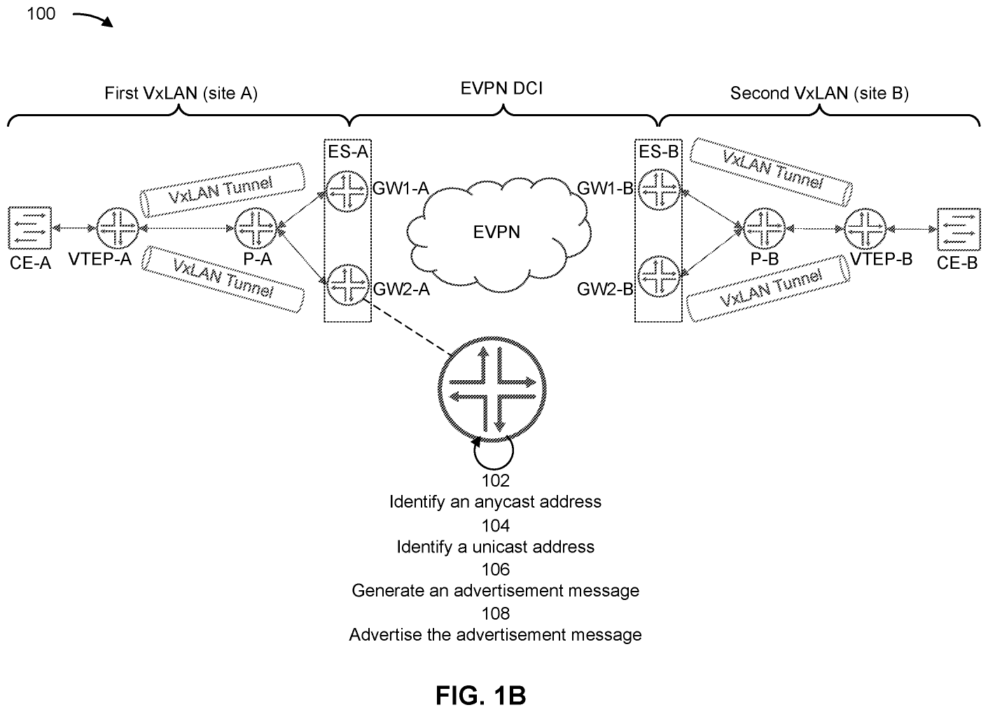

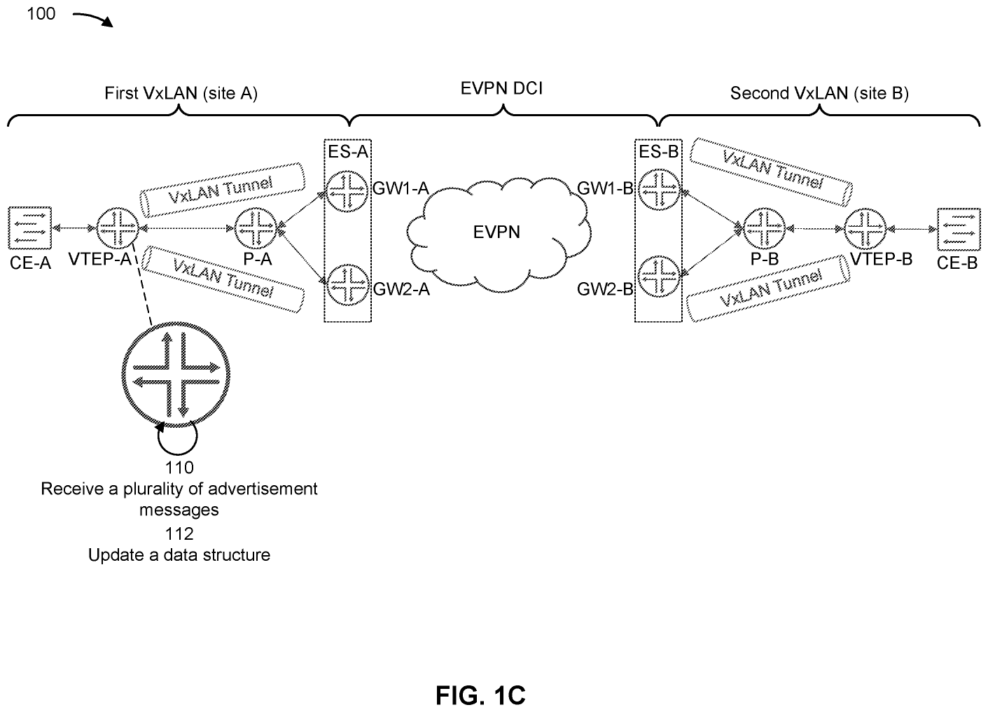

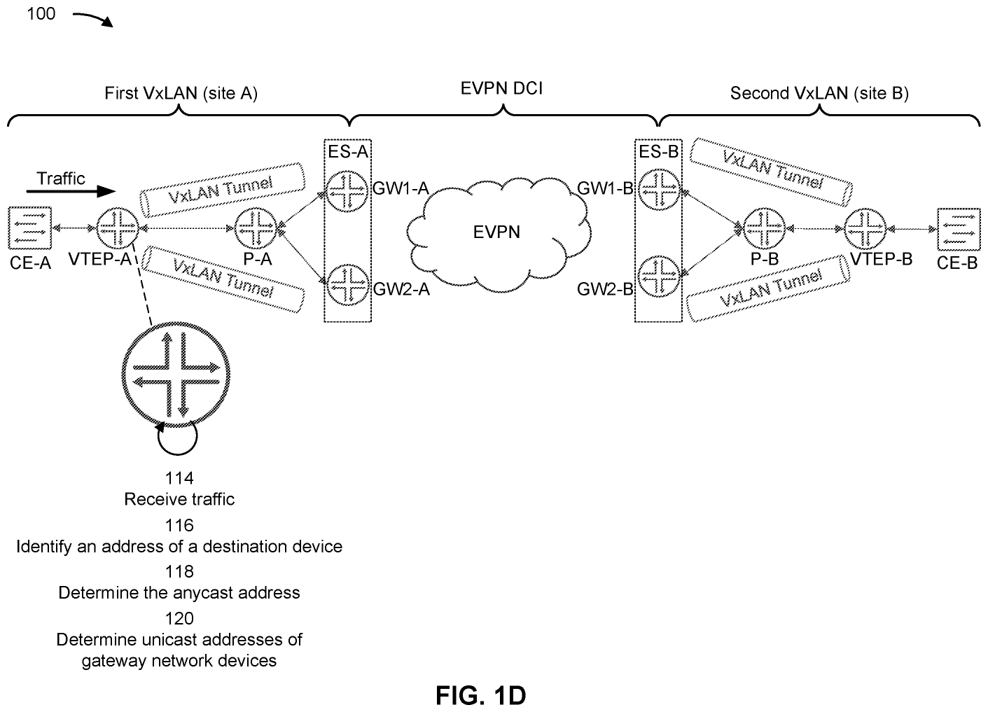

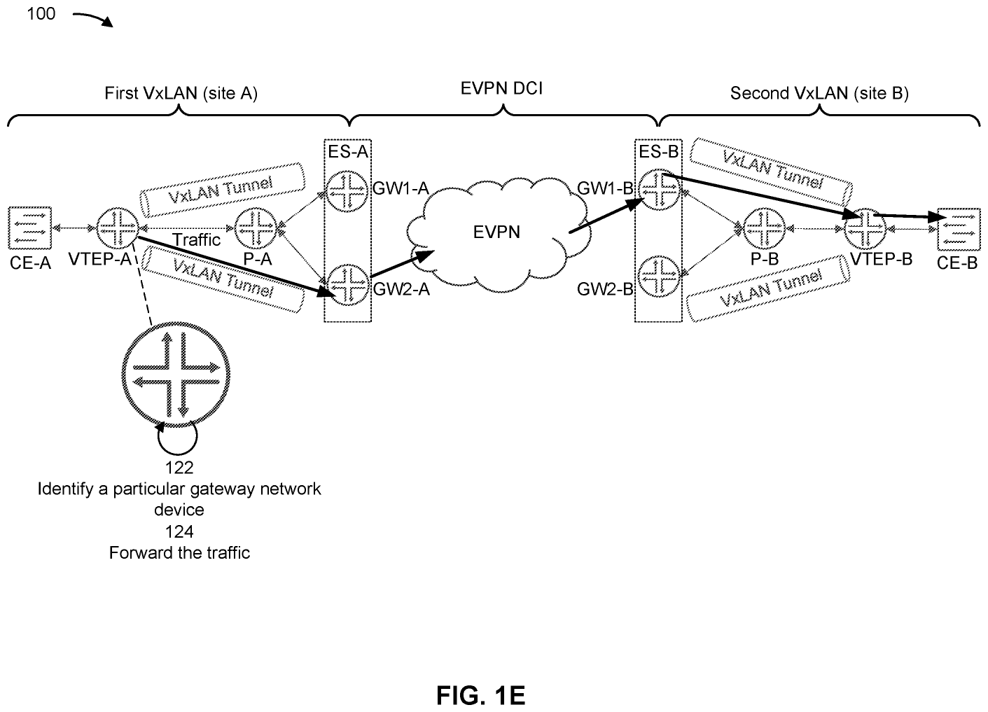

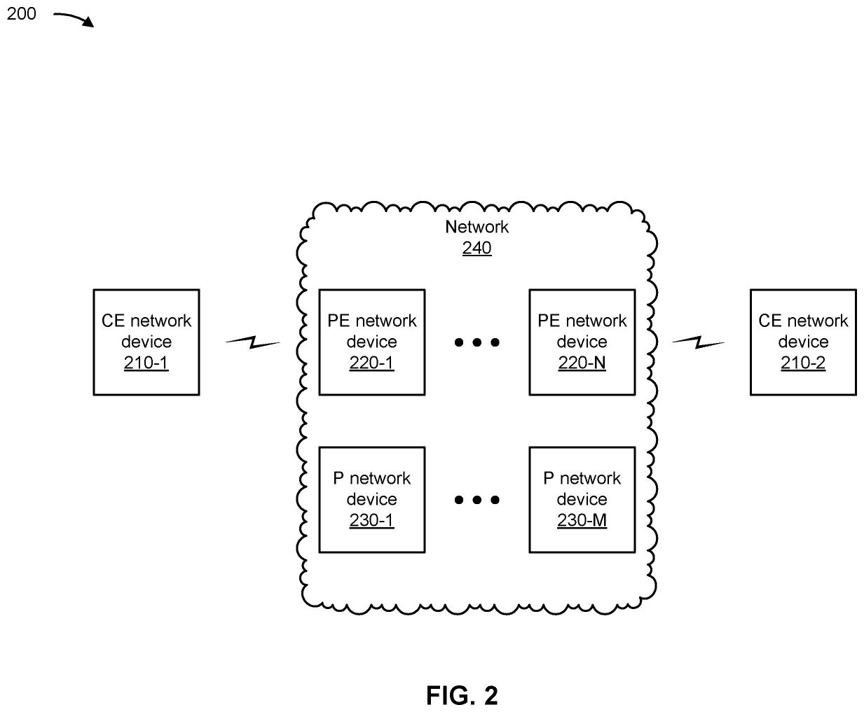

FIGS. 1A-1E are diagrams of one or more example implementations 100 described herein. Example implementation(s) 100 may include a plurality of network devices (e.g., CE network devices, PE network devices, and P network devices), which are described in more detail below in connection with FIGS. 2-4.

As shown in FIG. 1A, example implementation(s) 100 may include a first VxLAN (e.g., a first PIM-based dynamic VxLAN, also referred to as “site A”), a second VxLAN (e.g., a second PIM-based dynamic VxLAN, also referred to as “site B”), and an EVPN DCI (e.g., that connects the first VxLAN and the second VxLAN). The first VxLAN may include a CE network device A (“CE-A”), a PE network device that is configured as a VTEP (“VTEP-A”) connected to CE-A, a P network device configured as a provider router (“P-A”) connected to VTEP-A, and two PE network devices configured as gateway network devices (“GW1-A” and “GW2-A,” also referred to herein as gateways) connected to P-A. GW1-A and GW2-A may provide multihoming for site A (e.g., when run in all-active redundancy mode), such that a first VxLAN tunnel may be established between VTEP-A and GW1-A (e.g., via P-A) and a second VxLAN tunnel may be established between VTEP-A and GW2-A (e.g., via P-A). GW1-A and GW2-A may be at an edge of the EVPN DCI (e.g., may act as gateways between site A and the EVPN DCI) and may be associated with an Ethernet segment (ES) A (“ES-A”) of the EVPN DCI (e.g., that provides an EVPN shown in FIG. 1A). Accordingly, each of GW1-A and GW2-A may be a gateway network device of the EVPN DCI for the first VxLAN.

The second VxLAN may include a CE network device B (“CE-B”), a PE network device that is configured as a VTEP (“VTEP-B”) connected to CE-B, a P network device configured as a provider router (“P-B”) connected to VTEP-B, and two PE devices configured as gateway network devices (gateways “GW1-B” and “GW2-B”) connected to P-B. GW1-B and GW2-B may provide multihoming for site B (e.g., when run in all-active redundancy mode), such that a third VxLAN tunnel may be established between VTEP-B and GW1-B (e.g., via P-B) and a fourth VxLAN tunnel may be established between VTEP-B and GW2-B (e.g., via P-B). GW1-B and GW2-B may be at an edge of the EVPN DCI (e.g., may act as gateways between site B and the EVPN DCI) and may be associated with an ES B (“ES-B”) of the EVPN DCI. Accordingly, each of GW1-B and GW2-B may be a gateway network device of the EVPN DCI for the second VxLAN.

FIG. 1B shows one or more processing steps that may be performed by one of the gateway network devices associated with the first VxLAN. While FIG. 1B shows GW2-A performing the one or more processing steps, the one or more processing steps may be performed by GW1-A, or the one or more processing steps may be performed by each of GW2-A and GW1-A (e.g., independently of each other).

As shown in FIG. 1B, and by reference number 102, the gateway network device may identify an anycast address that is associated with the EVPN DCI. For example, the gateway network device may process (e.g., parse and/or read) configuration information included in the gateway network device to identify the anycast address. The anycast address may be associated with an address (e.g., a medium access control (MAC) address, or another address) of the CE-B associated with the second VxLAN. In this way, a network device of the first VxLAN (e.g., the VTEP-A) may send traffic that is destined for the address of the CE-B to the anycast address. This allows the traffic to be transmitted to one of the gateway network devices (e.g., via the first VxLAN tunnel or the second VxLAN tunnel), which then may forward the traffic to the CE-B (e.g., via the EVPN DCI and the second VxLAN).

As shown by reference number 104, the gateway network device may identify a unicast address of the gateway network device (e.g., that is different than the anycast address). For example, the gateway network device may process (e.g., parse and/or read) the configuration information included in the gateway network device to identify the unicast address. In some implementations, the gateway network device may have a plurality of unicast addresses. Accordingly, the gateway network device may identify the plurality of unicast addresses of the gateway network device (e.g., based on the configuration information).

As shown by reference number 106, the gateway network device may generate an advertisement message (also referred to herein as an advertisement). The advertisement message may indicate the anycast address and the unicast address (or the plurality of unicast addresses) of the gateway network device. In some implementations, the advertisement message may be an intermediate system to intermediate system (ISIS) message (e.g., an ISIS advertisement message), an open shortest path first (OSPF) message (e.g., an OSPF advertisement message), a border gateway protocol (BGP) message (e.g., a BGP advertisement message), or another type of message. For example, the anycast address and the unicast address (or the plurality of unicast addresses) may be included in a sub-type-length-value (sub-TLV) of an ISIS type-length-value (TLV) (e.g., an ISIS extended reachability TLV, such as with an anycast host prefix), in a sub-TLV of an OSPFv2 TLV (e.g., an OSPFv2 extended prefix TLV, such as with an anycast host prefix), in a sub-TLV of an OSPFv3 TLV (e.g., an OSPFv3 intra-area-prefix TLV or an OSPFv3 inter-area-prefix TLV, such as with an anycast host prefix), or in a sub-type that is attached to network layer routing information (NLRI) (e.g., for IPv4 or IPv6 address specific extended communities, such as where a global administrator field is set to the unicast address and a local administrator field is set to 0 (zero)).

As shown by reference number 108, the gateway network device may advertise the advertisement message. For example, the gateway network device may advertise (e.g., forward) the advertisement message to one or more other network devices in the first VxLAN (e.g., one or more of CE-A, VTEP-A, P-A, or the other gateway network device of the first VxLAN). The gateway network device may advertise the advertisement message according to a protocol, such as ISIS, OSPF, or BGP, among other examples.

As shown in FIG. 1C, and by reference number 110, VTEP-A may receive a plurality of advertisement messages (e.g., from the gateway network devices, or from one or more controllers associated with the gateway network devices, such as one or more controllers associated with the first VxLAN). For example, GW1-A and GW2-A may each advertise an advertisement message (e.g., as described herein in relation to FIG. 1A), and, accordingly, VTEP-A may receive the advertised advertisement messages. In a specific example, VTEP-A may receive a first advertisement message (e.g., generated by GW1-A) that indicates an anycast address and a unicast address (or a plurality of unicast addresses) of GW1-A, and a second advertisement message (e.g., generated by GW2-A) that indicates the anycast address (e.g., the same anycast address as indicated by the first advertisement message) and a unicast address (or a plurality of unicast addresses) of GW2-A. In this way, VTEP-A may determine that the unicast address (or the plurality of unicast addresses) of GW1-A and the unicast address (or the plurality of unicast addresses) of GW2-A are associated with the anycast address.

As shown by reference number 112, VTEP-A may update a data structure (e.g., a database, a table, a file, or another data structure, hereinafter referred to as the “first data structure”). The first data structure may be included in and/or may be accessible to VTEP-A. VTEP-A may update the first data structure based on the plurality of advertisement messages. For example, VTEP-A may update the first data structure to cause an entry of the first data structure to include the anycast address and the respective unicast address of the plurality of the gateway network devices. In a specific example, VTEP-A may update the first data structure to cause an entry of the first data structure to include the anycast address (e.g., cause the entry to be keyed to the anycast address), the unicast address (or the plurality of unicast addresses) of GW1-A, and the unicast address (or the plurality of unicast addresses) of GW2-A.

Alternatively, VTEP-A may include configuration information that indicates the anycast address and the respective unicast addresses of the plurality of the gateway network devices. For example, the configuration information may indicate the anycast address, the unicast address (or the plurality of unicast addresses) of GW1-A, and the unicast address (or the plurality of unicast addresses) of GW2-A. Accordingly, VTEP-A may determine, based on the configuration information, the respective unicast addresses of the plurality of the gateway network devices and/or that the anycast address is associated with the plurality of gateway network devices. VTEP-A may thereby update the first data structure to cause an entry of the first data structure to include the anycast address and the respective unicast addresses of the plurality of the gateway network devices. In this way, in some implementations, the plurality of gateway network devices do not need to generate and advertise advertisement messages related to the anycast address and the respective unicast addresses of the plurality of the gateway network devices, which conserves computing resources (e.g., processing resources, memory resources, communication resources, and/or power resources, among other examples) of the plurality of gateway network devices, as compared to other implementations that include the plurality of gateway network devices generating and advertising advertisement messages.

As shown in FIG. 1D and by reference number 114, VTEP-A may receive traffic from an origination device associated with the first VxLAN, such as CE-A. The traffic may be destined for a destination device associated with the second VxLAN, such as CE-B (e.g., the traffic may include the address of CE-B as a destination address of the traffic).

As shown by reference number 116, VTEP-A may identify an address of the destination device included in the traffic. For example, VTEP-A may identify the address of CE-B included in the traffic. VTEP-A may process (e.g., parse and/or read) the traffic to identify the address of the destination device.

As shown by reference number 118, VTEP-A may determine the anycast address that is associated with the EVPN DCI. For example, VTEP-A may search, based on the address of the destination device, another data structure (e.g., that is included in and/or is accessible to VTEP-A, hereinafter referred to as the “second data structure,”), to identify an entry (e.g., keyed to the address of the destination device) that indicates the anycast address of the plurality of gateway network devices. In a specific example, VTEP-A may search, based on the address of CE-B, the second data structure to identify an entry that indicates the anycast address of GW1-A and GW2-A. While some implementations described herein are directed to VTEP-A determining the anycast address based on the address of the destination device, other implementations include VTEP-A determining the anycast address in any manner, such as when the traffic is an Ethernet frame (e.g., in a VxLAN DCI case) and VTEP-A determines that anycast address to include an IP encapsulation of the traffic. In this way, based on a determination of the anycast address by VTEP-A, the traffic is to be forwarded to the anycast address.

VTEP-A may update and maintain the second data structure based on receiving other traffic from the second VxLAN, such as via GW1-A and/or GW2-A. For example, VTEP-A, when receiving other traffic from CE-B, via GW1-A and/or GW2-A, may identify a relationship between the address of CE-B and the anycast address of GW1-A and/or GW2-A, and may update the entry of the second data structure to indicate the address of CE-B and the anycast address of GW1-A and GW2-A.

As shown by reference number 120, VTEP-A may determine respective unicast addresses of the gateway network devices. For example, VTEP-A may search, based on the anycast address (e.g., that was determined by VTEP-A), the first data structure for an entry included in the first data structure that indicates that the respective unicast addresses of the plurality of gateway network devices are associated with the anycast address. VTEP-A then may determine, based on the entry, the respective unicast addresses of the plurality of gateway network devices (e.g., by parsing and/or reading the entry). In a specific example, VTEP-A may identify, based on the anycast address, an entry included in the first data structure that indicates the unicast address (or the plurality of unicast addresses) of GW1-A and the unicast address (or the plurality of unicast addresses) of GW2-A. VTEP-A then may determine, based on the entry, the unicast address (or the plurality of unicast addresses) of GW1-A and the unicast address (or the plurality of unicast addresses) of GW2-A.

As shown in FIG. 1E, and by reference number 122, VTEP-A may identify a particular gateway network device, of the gateway network devices, to which the traffic is to be forwarded. For example, VTEP-A may select, using a load-balancing technique and/or another selection technique, and based on the respective unicast addresses of the plurality of gateway network devices, a particular gateway network device (or a particular unicast address that is associated with the particular gateway network device). The load-balancing technique and/or other selection technique may include monitoring, based on the respective unicast addresses of the plurality of gateway network devices, traffic flows to the gateway network devices. In a specific example, as shown in FIG. 1E, VTEP-A may select GW2-A as the particular gateway network device to which the traffic is to be forwarded.

As shown by reference number 124, VTEP-A may forward (e.g., send) the traffic to a unicast address of the particular gateway network device. For example, VTEP-A may identify a unicast address, of the respective unicast addresses of the gateway network devices, that is associated with the particular gateway network device, and may thereby forward the traffic to the unicast address of the particular gateway network device. In a specific example, as shown in FIG. 1E, VTEP-A may identify the unicast address (or a single unicast address of the plurality of unicast addresses) of GW2-A, and may thereby forward the traffic to the unicast address of GW2-A.

Accordingly, the gateway network device may receive the traffic (e.g., via the unicast address of the gateway network device). In a specific example, GW2-A may receive the traffic via the unicast address of GW2-A. This permits the traffic to be transmitted, via the EVPN DCI and the second VxLAN, to the address of the destination device associated with the second VxLAN. For example, GW2-A may forward the traffic to permit the traffic to transmit, via the EVPN DCI and the second VxLAN, to the address of CE-B.

As indicated above, FIGS. 1A-1E are provided merely as one or more examples. Other examples may differ from what is described with regard to FIGS. 1A-IE.

FIG. 2 is a diagram of an example environment 200 in which systems and/or methods described herein may be implemented. As shown in FIG. 2, environment 200 may include a plurality of CE network devices 210 (shown as CE network devices 210-1 and 210-2), a plurality of PE network devices 220 (shown as PE devices 220-1 through 220-N), a plurality of P network devices 230 (shown as P devices 230-1 through 230-M), and a network 240. Devices of environment 200 may interconnect via wired connections, wireless connections, or a combination of wired and wireless connections.

A CE network device 210 includes one or more devices capable of generating, sending, receiving, processing, storing, routing, and/or providing traffic in a manner described herein. For example, a CE network device 210 may include a firewall, a gateway, a switch, a hub, a bridge, a reverse proxy, a server (e.g., a proxy server), a security device, an intrusion detection device, a load balancer, or a similar type of device. Additionally, or alternatively, a CE network device 210 may include a router, such as a label switching router (LSR), a label edge router (LER), an ingress router, an egress router, a provider router (e.g., a provider edge router or a provider core router), a virtual router, or another type of router. In some implementations, a CE network device 210 may include a mobile phone (e.g., a smart phone or a radiotelephone), a laptop computer, a tablet computer, a desktop computer, a handheld computer, or a similar type of device. A CE network device 210 may be connected to a PE network device 220 via a P network device 230. A CE network device 210 may be a physical device implemented within a housing, such as a chassis. In some implementations, a CE network device 210 may be a virtual device implemented by one or more computer devices of a cloud computing environment or a data center.

A PE network device 220 includes one or more devices capable of receiving, processing, storing, routing, and/or providing traffic in a manner described herein. For example, a PE network device 220 may include a firewall, a gateway, a switch, a hub, a bridge, a reverse proxy, a server (e.g., a proxy server), a security device, an intrusion detection device, a load balancer, or a similar type of device. Additionally, or alternatively, a PE network device 220 may include a router, such as an LSR, an LER, an ingress router, an egress router, a provider router (e.g., a provider edge router or a provider core router), a virtual router, or another type of router. In some implementations, a PE network device 220 may include a link that connects the PE network device 220 to a P network device 230. A PE network device 220 may be a physical device implemented within a housing, such as a chassis. In some implementations, a PE network device 220 may be a virtual device implemented by one or more computer devices of a cloud computing environment or a data center.

A P network device 230 includes one or more devices capable of receiving, processing, storing, routing, and/or providing traffic in a manner described herein. For example, a P network device 230 may include a firewall, a gateway, a switch, a hub, a bridge, a reverse proxy, a server (e.g., a proxy server), a security device, an intrusion detection device, a load balancer, or a similar type of device. Additionally, or alternatively, a P network device 230 may include a router, such as an LSR, an LER, an ingress router, an egress router, a provider router (e.g., a provider edge router or a provider core router), a virtual router, or another type of router. A P network device 230 may be a physical device implemented within a housing, such as a chassis. In some implementations, a P network device 230 may be a virtual device implemented by one or more computer devices of a cloud computing environment or a data center.

Network 240 includes one or more wired and/or wireless networks. For example, network 240 may include a packet switched network, a cellular network (e.g., a fifth generation (5G) network, a fourth generation (4G) network, such as a long-term evolution (LTE) network, a third generation (3G) network, a code division multiple access (CDMA) network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as one or more examples. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

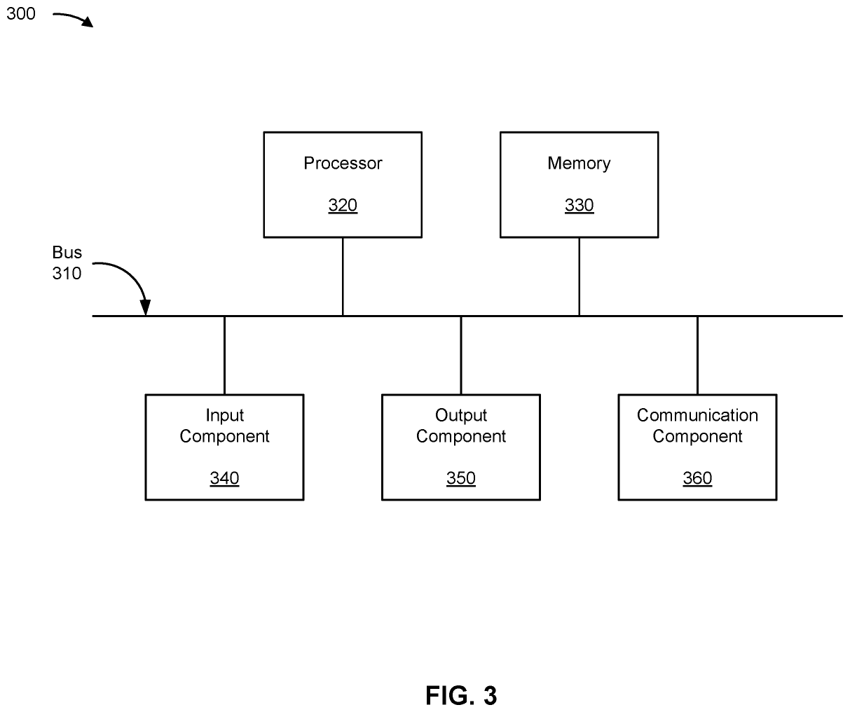

FIG. 3 is a diagram of example components of a device 300, which may correspond to a CE network device 210, a PE network device 220, and/or a P network device 230. In some implementations, the CE network device 210, the PE network device 220, and/or the P network device 230 may include one or more devices 300 and/or one or more components of device 300. As shown in FIG. 3, device 300 may include a bus 310, a processor 320, a memory 330, an input component 340, an output component 350, and a communication component 360.

Bus 310 includes one or more components that enable wired and/or wireless communication among the components of device 300. Bus 310 may couple together two or more components of FIG. 3, such as via operative coupling, communicative coupling, electronic coupling, and/or electric coupling. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform one or more operations or processes described elsewhere herein.

Memory 330 includes volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 includes one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

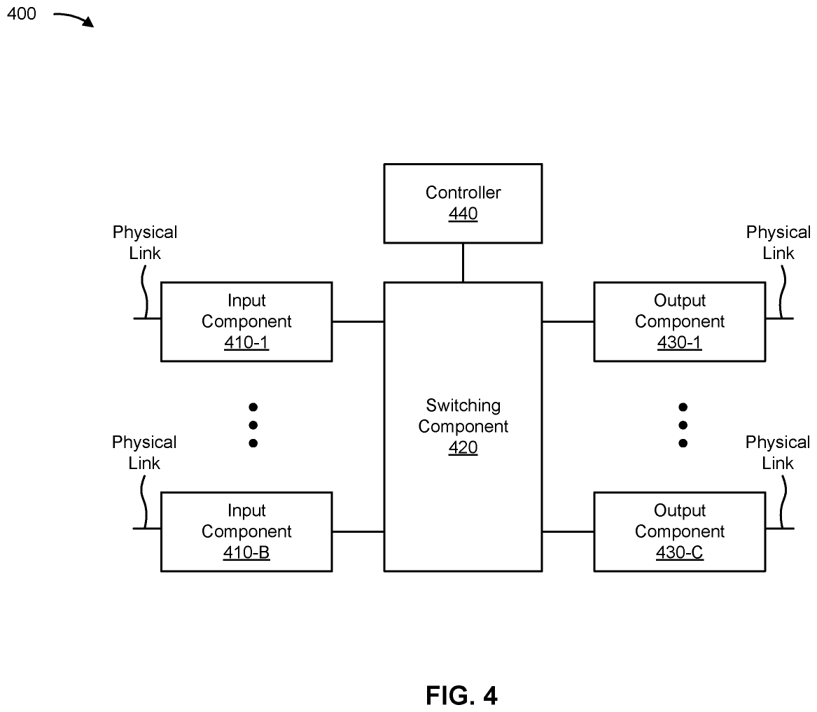

FIG. 4 is a diagram of example components of a device 400. Device 400 may correspond to a CE network device 210, a PE network device 220, and/or a P network device 230. In some implementations, the CE network device 210, the PE network device 220, and/or the P network device 230 may include one or more devices 400 and/or one or more components of device 400. As shown in FIG. 4, device 400 may include one or more input components 410-1 through 410-B (B≥1) (hereinafter referred to collectively as input components 410, and individually as input component 410), a switching component 420, one or more output components 430-1 through 430-C (C≥1) (hereinafter referred to collectively as output components 430, and individually as output component 430), and a controller 440.

Input component 410 may be one or more points of attachment for physical links and may be one or more points of entry for incoming traffic, such as packets. Input component 410 may process incoming traffic, such as by performing data link layer encapsulation or decapsulation. In some implementations, input component 410 may transmit and/or receive packets. In some implementations, input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, device 400 may include one or more input components 410.

Switching component 420 may interconnect input components 410 with output components 430. In some implementations, switching component 420 may be implemented via one or more crossbars, via busses, and/or with shared memories. The shared memories may act as temporary buffers to store packets from input components 410 before the packets are eventually scheduled for delivery to output components 430. In some implementations, switching component 420 may enable input components 410, output components 430, and/or controller 440 to communicate with one another.

Output component 430 may store packets and may schedule packets for transmission on output physical links. Output component 430 may support data link layer encapsulation or decapsulation, and/or a variety of higher-level protocols. In some implementations, output component 430 may transmit packets and/or receive packets. In some implementations, output component 430 may include an output line card that includes one or more packet processing components (e.g., in the form of integrated circuits), such as one or more IFCs, packet forwarding components, line card controller components, output ports, processors, memories, and/or output queues. In some implementations, device 400 may include one or more output components 430. In some implementations, input component 410 and output component 430 may be implemented by the same set of components (e.g., and input/output component may be a combination of input component 410 and output component 430).

Controller 440 includes a processor in the form of, for example, a CPU, a GPU, an APU, a microprocessor, a microcontroller, a DSP, an FPGA, an ASIC, and/or another type of processor. The processor is implemented in hardware, firmware, or a combination of hardware and software. In some implementations, controller 440 may include one or more processors that can be programmed to perform a function.

In some implementations, controller 440 may include a RAM, a ROM, and/or another type of dynamic or static storage device (e.g., a flash memory, a magnetic memory, an optical memory, etc.) that stores information and/or instructions for use by controller 440.

In some implementations, controller 440 may communicate with other devices, networks, and/or systems connected to device 400 to exchange information regarding network topology. Controller 440 may create routing tables based on the network topology information, may create forwarding tables based on the routing tables, and may forward the forwarding tables to input components 410 and/or output components 430. Input components 410 and/or output components 430 may use the forwarding tables to perform route lookups for incoming and/or outgoing packets.

Controller 440 may perform one or more processes described herein. Controller 440 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with controller 440 from another computer-readable medium or from another device via a communication interface. When executed, software instructions stored in a memory and/or storage component associated with controller 440 may cause controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

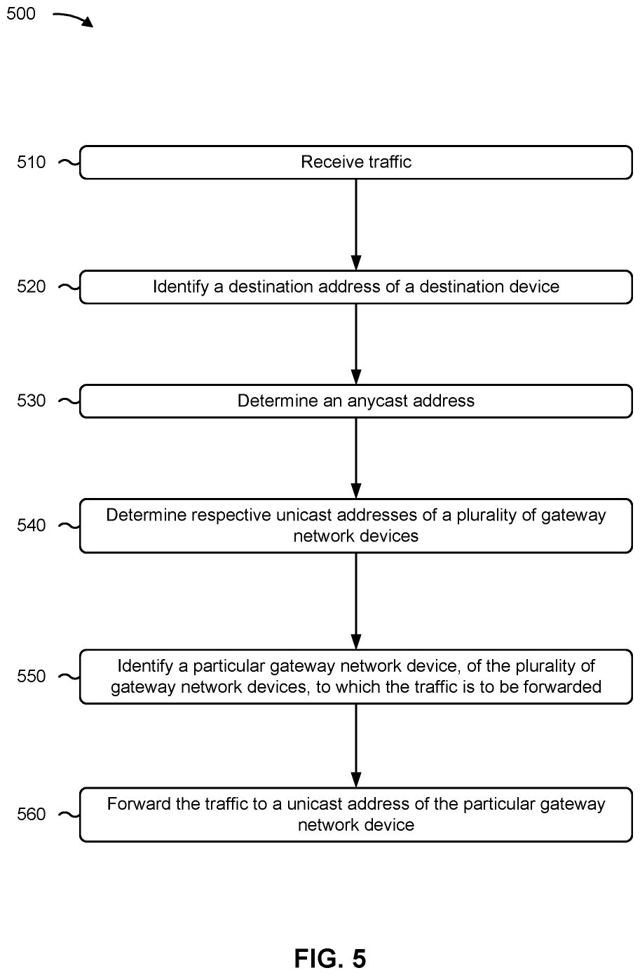

FIG. 5 is a flowchart of an example process 500 associated with determining unicast addresses of gateway network devices associated with an anycast address in VxLAN-EVPN DCI environments. In some implementations, one or more process blocks of FIG. 5 are performed by a network device (e.g., a PE network device 220). In some implementations, one or more process blocks of FIG. 5 are performed by another device or a group of devices separate from or including the network device, such as another network device (e.g., a CE network device 210, another PE network device 220, or a P network device 230). Additionally, or alternatively, one or more process blocks of FIG. 5 may be performed by one or more components of device 300, such as processor 320, memory 330, input component 340, output component 350, and/or communication component 360; one or more components of device 400, such as input component 410, switching component 420, output component 430, and/or controller 440; and/or one or more other components.

As shown in FIG. 5, process 500 may include receiving traffic (block 510). For example, the network device may receive, from an origination device associated with a first VxLAN, traffic destined for a destination device associated with a second VxLAN, as described above. In some implementations, the network device is a VTEP of the first VxLAN.

As further shown in FIG. 5, process 500 may include identifying an address of a destination device (block 520). For example, the network device may identify an address of the destination device included in the traffic, as described above.

As further shown in FIG. 5, process 500 may include determining an anycast address (block 530). For example, the network device may determine, based on the address of the destination device, an anycast address associated with an EVPN DCI that is associated with the first VxLAN and the second VxLAN, as described above.

As further shown in FIG. 5, process 500 may include determining respective unicast addresses of a plurality of gateway network devices (block 540). For example, the network device may determine, based on the anycast address, respective unicast addresses of a plurality of gateway network devices associated with the EVPN DCI, as described above.

As further shown in FIG. 5, process 500 may include identifying a particular gateway network device, of the plurality of gateway network devices, to which the traffic is to be forwarded (block 550). For example, the network device may identify, based on the respective unicast addresses of the plurality of gateway network devices, a particular gateway network device, of the plurality of gateway network devices, to which the traffic is to be forwarded, as described above.

As further shown in FIG. 5, process 500 may include forwarding the traffic to a unicast address of the particular gateway network device (block 560). For example, the network device may forward the traffic to a unicast address of the particular gateway network device, as described above.

Process 500 may include additional implementations, such as any single implementation or any combination of implementations described below and/or in connection with one or more other processes described elsewhere herein.

In a first implementation, forwarding the traffic to the unicast address of the particular gateway network device permits the traffic to be transmitted, via the EVPN DCI and the second VxLAN, to the address of the destination device associated with the second VxLAN.

In a second implementation, alone or in combination with the first implementation, process 500 includes receiving, prior to receiving the traffic, a plurality of advertisement messages from the plurality of gateway network devices, wherein an advertisement message received from a gateway network device, of the plurality of gateway network devices, indicates the anycast address, and a unicast address of the gateway network device.

In a third implementation, alone or in combination with one or more of the first and second implementations, each advertisement message is an ISIS advertisement message, an OSPF advertisement message, or a BGP advertisement message.

In a fourth implementation, alone or in combination with one or more of the first through third implementations, process 500 includes updating, based on the plurality of advertisement messages, a data structure to cause an entry of the data structure to include the anycast address and the respective unicast addresses of the plurality of gateway network devices.

In a fifth implementation, alone or in combination with one or more of the first through fourth implementations, process 500 includes determining, prior to receiving the traffic and based on configuration information included in the network device, the respective unicast addresses of the plurality of gateway network devices.

In a sixth implementation, alone or in combination with one or more of the first through fifth implementations, process 500 includes determining that the anycast address is associated with the plurality of gateway network devices, and updating, based on determining the respective unicast addresses of the plurality of gateway network devices and on determining that the anycast address is associated with the plurality of gateway network devices, a data structure to cause an entry of the data structure to include the anycast address and the respective unicast addresses of the plurality of gateway network devices.

In a seventh implementation, alone or in combination with one or more of the first through sixth implementations, determining the respective unicast addresses of the plurality of gateway network devices comprises searching, based on the anycast address, a data structure for an entry included in the data structure, wherein the entry indicates that the respective unicast addresses of the plurality of gateway network devices are associated with the anycast address, and determining, based on the entry, the respective unicast addresses of the plurality of gateway network devices.

In an eighth implementation, alone or in combination with one or more of the first through seventh implementations, identifying the particular gateway network device to which the traffic is to be forwarded comprises selecting, using a load-balancing technique and based on the respective unicast addresses of the plurality of gateway network devices, the particular gateway network device.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

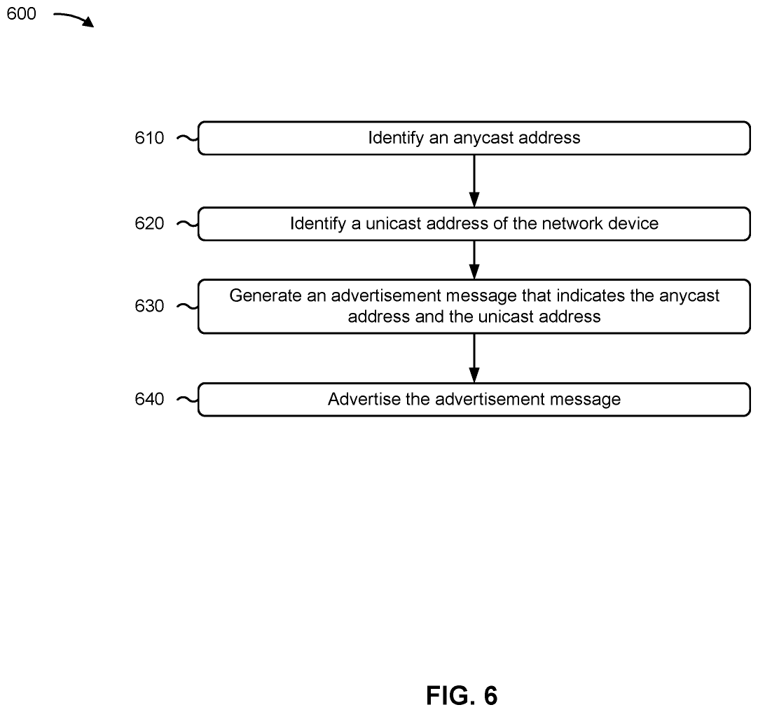

FIG. 6 is a flowchart of an example process 600 associated with determining unicast addresses of gateway network devices associated with an anycast address in VxLAN-EVPN DCI environments. In some implementations, one or more process blocks of FIG. 6 are performed by a network device (e.g., a PE network device 220). In some implementations, one or more process blocks of FIG. 6 are performed by another device or a group of devices separate from or including the network device, such as another network device (e.g., a CE network device 210, another PE network device 220, or a P network device 230). Additionally, or alternatively, one or more process blocks of FIG. 6 may be performed by one or more components of device 300, such as processor 320, memory 330, input component 340, output component 350, and/or communication component 360; one or more components of device 400, such as input component 410, switching component 420, output component 430, and/or controller 440; and/or one or more other components.

As shown in FIG. 6, process 600 may include identifying an anycast address (block 610). For example, the network device may identify an anycast address that is associated with an EVPN DCI that is associated with a first VxLAN and a second VxLAN, wherein the network device is a gateway network device of the EVPN DCI for the first VxLAN, as described above. In some implementations, the network device is a gateway network device of the EVPN DCI for the first VxLAN.

As further shown in FIG. 6, process 600 may include identifying a unicast address of the network device (block 620). For example, the network device may identify a unicast address of the network device, as described above.

As further shown in FIG. 6, process 600 may include generating an advertisement message that indicates the anycast address and the unicast address (block 630). For example, the network device may generate an advertisement message that indicates the anycast address and the unicast address, as described above.

As further shown in FIG. 6, process 600 may include advertising the advertisement message (block 640). For example, the network device may advertise the advertisement message to one or more other network devices associated with the first VxLAN, as described above.

Process 600 may include additional implementations, such as any single implementation or any combination of implementations described below and/or in connection with one or more other processes described elsewhere herein.

In a first implementation, the advertisement message is an ISIS advertisement message, an OSPF advertisement message, or a BGP advertisement message.

In a second implementation, alone or in combination with the first implementation, process 600 includes receiving, after advertising the advertisement message, traffic from a VTEP network device of the first VxLAN, wherein the traffic is received via the unicast address of the network device.

In a third implementation, alone or in combination with one or more of the first and second implementations, process 600 includes forwarding the traffic to permit the traffic to transmit, via the EVPN DCI and the second VxLAN, to an address of a destination device associated with the second VxLAN, wherein the address of the destination device is included in the traffic.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, traffic or content may include a set of packets. A packet may refer to a communication structure for communicating information, such as a protocol data unit (PDU), a service data unit (SDU), a network packet, a datagram, a segment, a message, a block, a frame (e.g., an Ethernet frame), a portion of any of the above, and/or another type of formatted or unformatted unit of data capable of being transmitted via a network.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a first network device, traffic that is to be forwarded to an anycast address associated with a second network device and a third network device; and
sending, by the first network device, the traffic to a unicast address of one or more unicast addresses associated with the anycast address.

2. The method of claim 1, wherein:
the first network device determined that the one or more unicast addresses are associated with the anycast address based on advertisements.

3. The method of claim 1, wherein:
the first network device determined that the one or more unicast addresses are associated with the anycast address based on configuration information included in the first network device.

4. The method of claim 1, wherein:
the traffic is virtual extensible local area network (VxLAN) traffic, and the second network device and the third network device are Ethernet virtual private network data center interconnect (EVPN DCI) gateways.

5. The method of claim 2, wherein:
the advertisements originated from the second network device, the third network device, or one or more other network devices; and
the advertisements are intermediate system to intermediate system (ISIS) messages, border gateway protocol (BGP) messages, or open shortest path first (OSPF) messages.

6. The method of claim 2, wherein:
the advertisements are from one or more controllers.

7. The method of claim 1, wherein sending the traffic to the unicast address comprises:
selecting, using a load-balancing technique, the unicast address from the one or more unicast addresses associated with the anycast address; and
sending, based on selecting the unicast address, the traffic to the unicast address.

8. A non-transitory computer-readable medium storing a set of instructions, the set of instructions comprising:
one or more instructions that, when executed by one or more processors of a first network device, cause the first network device to:
receive traffic that is to be forwarded to an anycast address associated with a second network device and a third network device; and
send the traffic to a unicast address of one or more unicast addresses associated with the anycast address.

9. The non-transitory computer-readable medium of claim 8, wherein:
the first network device determined that the one or more unicast addresses are associated with the anycast address based on advertisements.

10. The non-transitory computer-readable medium of claim 8, wherein:
the first network device determined that the one or more unicast addresses are associated with the anycast address based on configuration information included in the first network device.

11. The non-transitory computer-readable medium of claim 8, wherein:
the traffic is virtual extensible local area network (VxLAN) traffic, and the second network device and the third network device are Ethernet virtual private network data center interconnect (EVPN DCI) gateways.

12. The non-transitory computer-readable medium of claim 9, wherein:
the advertisements originated from the second network device, the third network device, or one or more other network devices; and
the advertisements are intermediate system to intermediate system (ISIS) messages, border gateway protocol (BGP) messages, or open shortest path first (OSPF) messages.

13. The non-transitory computer-readable medium of claim 9, wherein:
the advertisements are from one or more controllers.

14. The non-transitory computer-readable medium of claim 8, wherein the one or more instructions, that cause the first network device to send the traffic to the unicast address, cause the first network device to:
select, using a load-balancing technique, the unicast address from the one or more unicast addresses associated with the anycast address; and
send, based on selecting the unicast address, the traffic to the unicast address.

15. A network device, comprising:
one or more memories; and
one or more processors to:
identify an anycast address that is associated with the network device;
identify a unicast address of the network device; and
advertise the anycast address and the unicast address to one or more other network devices.

16. The network device of claim 15, wherein:
the anycast address and the unicast address are advertised via intermediate system to intermediate system (ISIS) messages, border gateway protocol (BGP) messages, or open shortest path first (OSPF) messages.

17. The network device of claim 15, wherein:
wherein the network device is an Ethernet virtual private network data center interconnect (EVPN DCI) gateway.

18. The network device of claim 17, wherein:
the EVPN DCI is associated with a first virtual extensible local area network (VxLAN) and a second VxLAN.

19. The network device of claim 15, wherein the one or more processors are further to:
receive, after advertising the anycast address and the unicast address, traffic from another network device that received advertisements from the network device.

20. The network device of claim 19, wherein:
the traffic is virtual extensible local area network (VxLAN) traffic.
